(19) United States
(12) Patent Application Publication
(10) Pub. No.: US 2021/0387383 A1
(43) Pub. Date: Dec. 16, 2021

(54) SILK THREAD MOLDED BODY, METHOD FOR MANUFACTURING SILK THREAD MOLDED BODY, AND METHOD FOR MANUFACTURING CELLULOSE FIBER REGENERATED MOLDED BODY

(71) Applicant: SEIKO EPSON CORPORATION, Tokyo (JP)

(72) Inventors: Sotaro OANA, Chino (JP); Makoto KATO, Shiojiri (JP); Hideki TANAKA, Chino (JP); Yoko NAKAI, Chino (JP)

(21) Appl. No.: 17/346,374

(22) Filed: Jun. 14, 2021

(30) Foreign Application Priority Data
Jun. 16, 2020 (JP) 2020-103561

(51) Int. Cl. B29C 43/00; B29B 13/10

(52) U.S. Cl. CPC B29C 43/003; B29K 2001/00; B29B 13/10

(57) ABSTRACT

A silk thread molded body is obtained by molding a coarsely pulverized silk thread material which is prepared by coarsely pulverizing silk threads.

The present application is based on, and claims priority from JP Application Serial Number 2020-103561, filed Jun. 16, 2020, the disclosure of which is hereby incorporated by reference herein in its entirety.

### BACKGROUND

### 1. Technical Field

The present disclosure relates to a silk thread molded body, a method for manufacturing a silk thread molded body, and a method for manufacturing a cellulose fiber regenerated molded body.

### 2. Related Art

Heretofore, as disclosed in JP-A-2015-92032, there has been known a sheet manufacturing method in which fibers and a composite material containing a resin are mixed with and bound to each other to form a sheet.

However, since the resin used for the above sheet manufacturing method is synthesized by using petroleum as a raw material, biodegradability of the sheet thus manufactured and environmental compatibility thereof are disadvantageously inferior.

### SUMMARY

According to an aspect of the present disclosure, there is provided a silk thread molded body obtained by molding a coarsely pulverized silk thread material which is prepared by coarsely pulverizing silk threads.

According to another aspect of the present disclosure, there is provided a method for manufacturing a silk thread molded body, the method comprising: a coarsely pulverizing step of coarsely pulverizing silk threads to obtain a coarsely pulverized silk thread material; a depositing step of dispersing in air and depositing the coarsely pulverized silk thread material to obtain a silk thread deposit; a moisture imparting step of imparting moisture to the silk thread deposit; and a molding step of pressurizing and heating the silk thread deposit to which the moisture is imparted to obtain a silk thread molded body.

According to another aspect of the present disclosure, there is provided a method for manufacturing a cellulose fiber regenerated molded body, the method comprising: a coarsely pulverizing step of coarsely pulverizing the silk thread molded body described above and a cellulose fiber molded body to obtain a coarsely pulverized material; a depositing step of dispersing in air and depositing the coarsely pulverized material to obtain a deposit; a moisture imparting step of imparting moisture to the deposit; and a molding step of pressurizing and heating the deposit to which the moisture is imparted to obtain a cellulose fiber regenerated molded body.

### BRIEF DESCRIPTION OF THE DRAWINGS

FIG. 1 is a schematic view showing the structure of a silk thread molded body.

FIG. 2 is a flowchart showing a method for manufacturing the silk thread molded body.

FIG. 3A is a schematic view showing the method for manufacturing the silk thread molded body.

FIG. 3B is a schematic view showing the method for manufacturing the silk thread molded body.

FIG. 3C is a schematic view showing the method for manufacturing the silk thread molded body.

FIG. 3D is a schematic view showing the method for manufacturing the silk thread molded body.

FIG. 3E is a schematic view showing the method for manufacturing the silk thread molded body.

FIG. 3F is a schematic view showing the method for manufacturing the silk thread molded body.

FIG. 4 is a schematic view showing the structure of a cellulose fiber regenerated molded body.

FIG. 5 is a flowchart showing a method for manufacturing the cellulose fiber regenerated molded body.

FIG. 6A is a schematic view showing the method for manufacturing the cellulose fiber regenerated molded body.

FIG. 6B is a schematic view showing the method for manufacturing the cellulose fiber regenerated molded body.

FIG. 6C is a schematic view showing the method for manufacturing the cellulose fiber regenerated molded body.

FIG. 6D is a schematic view showing the method for manufacturing the cellulose fiber regenerated molded body.

FIG. 6E is a schematic view showing the method for manufacturing the cellulose fiber regenerated molded body.

FIG. 6F is a schematic view showing the method for manufacturing the cellulose fiber regenerated molded body.

FIG. 7 is a schematic view showing the structure of a cellulose fiber regenerated molded body manufacturing apparatus.

### DESCRIPTION OF EXEMPLARY EMBODIMENTS

### 1. Silk Thread Molded Body Sa

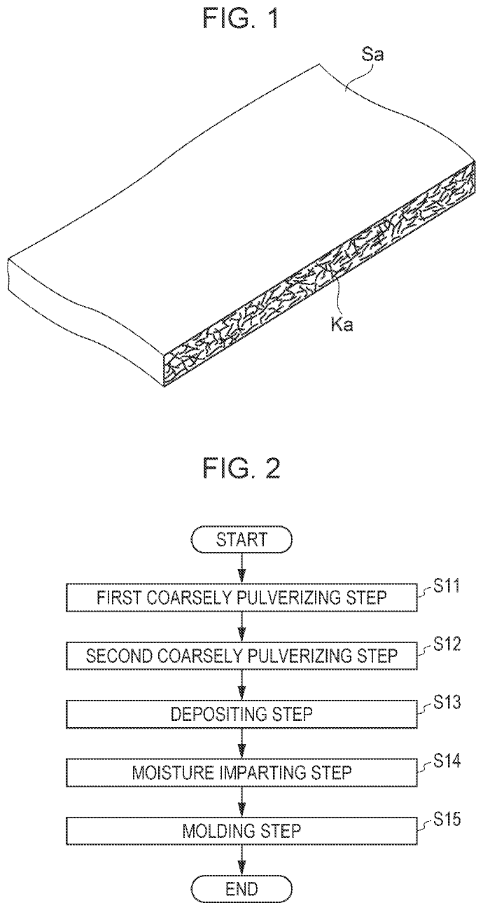

First, the structure of a silk thread molded body Sa will be described. FIG. 1 is a schematic view showing the structure of the silk thread molded body Sa. As shown in FIG. 1, the silk thread molded body Sa is obtained by molding a coarsely pulverized silk thread material Ka which is prepared by coarsely pulverizing silk threads. The coarsely pulverized silk thread material Ka contains sericin and fibroin.

The sericin contained in the coarsely pulverized silk thread material Ka is derived from house silkworms and wild silkworms. As the house silkworms and the wild silkworms, for example, there may be mentioned Bombyx mandarina, Cambodge, Rondotia menciana, Bombyx huttoni, Antheraea yamamai, Antheraea pernyi, Antheraea mylitta, Antheraea assama, Samia cynthia ricini, Red Samia cynthia ricini, Caligula japonica, Attacus atlas ryukyuensis, Hyalophora cecropia, Cricula trifenestrata, Samia cynthia pryeri, Actias aliena, Rhodinia fugax, Rothschildia erycina, Borocera, Dendrolimus spectabilis, Gonometa, Pachipasa otus, Anaphe reticulate, cross-bred silkworms therebetween, and transgenic silkworms.

As is the sericin, the fibroin contained in the coarsely pulverized silk thread material Ka is derived from house silkworms and wild silkworms. House silkworms contain sericin and fibroin at a mass ratio of sericin to fibroin of approximately 3 to 7.

Since being formed from silk threads which are natural fibers derived from animals, the silk thread molded body Sa is biodegradable and excellent in environmental compatibility.

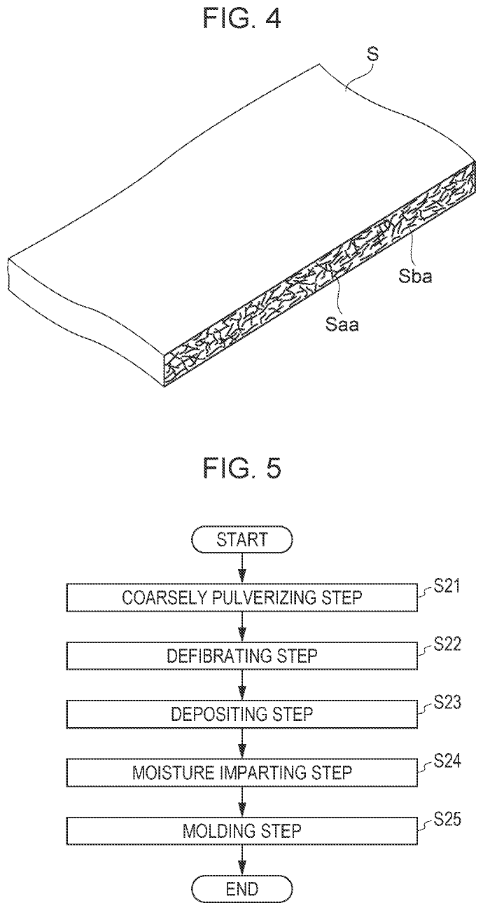

In addition, for example, when a cellulose fiber regenerated molded body S (see FIG. 4) is manufactured, the silk thread molded body Sa may be used as a binding material to bind cellulose fibers Sba together. In this case, the binding material can be fully formed from natural materials. In addition, since the naturally-derived binding material is used, a cellulose fiber regenerated molded body S excellent in environmental compatibility can be provided.

The coarsely pulverized silk thread material Ka may be in the form of small pieces each having a several millimeters square or may also be in the form of fibers. The coarsely pulverized silk thread material Ka of this embodiment is in the form of fibers, and an average fiber length thereof is 0.5 to 5.0 mm. Accordingly, a silk thread molded body Sa having a flexibility can be molded. In addition, the tensile strength of the silk thread molded body Sa to be obtained can be further increased.

In addition, the silk thread molded body Sa of this embodiment is formed to have a sheet shape. That is, the silk thread molded body Sa is not in the form of particles. The thickness of the silk thread molded body Sa is, for example, 0.05 to 1.0 mm. That is, the silk thread molded body Sa of this embodiment is formed to have a shape similar to that of general paper (such as A4-sized paper) or the cellulose fiber regenerated molded body S. Accordingly, the silk thread molded body Sa can be supplied, for example, by an existing transport mechanism, and smooth transportation can be performed. For example, when the cellulose fiber regenerated molded body S is manufactured, transportation can be performed in a manner similar to that for a cellulose fiber molded body, such as old paper, to be used as a raw material, and hence, the cellulose fiber regenerated molded body S can be efficiently manufactured.

### 2. Method for Manufacturing Silk Thread Molded Body Sa

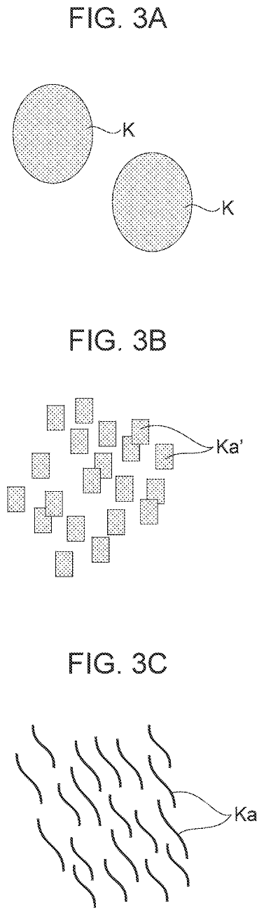

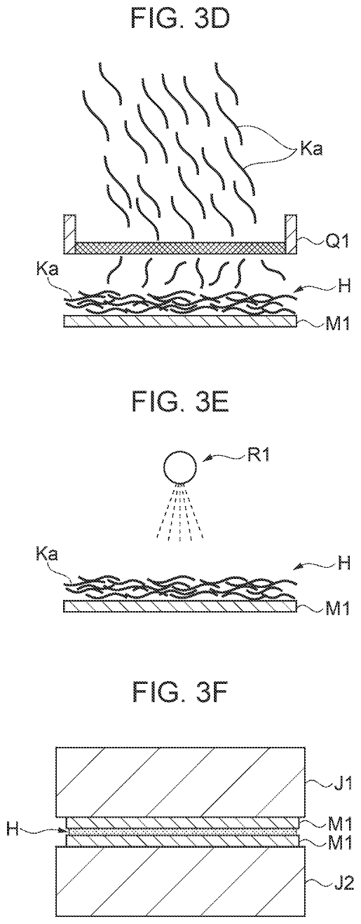

Next, a method for manufacturing the silk thread molded body Sa will be described. FIG. 2 is a flowchart showing the method for manufacturing the silk thread molded body Sa. FIGS. 3A to 3F are schematic views each showing the method for manufacturing the silk thread molded body Sa.

First, in a coarsely pulverizing step, the coarsely pulverized silk thread material Ka is formed by coarsely pulverizing silk threads K. In addition, the coarsely pulverizing step of this embodiment includes a first coarsely pulverizing step and a second coarsely pulverizing step. Hereinafter, the coarsely pulverizing step will be described in detail.

In a first coarsely pulverizing step of Step S11, the silk threads K are coarsely pulverized, and as shown in FIG. 3B, coarsely pulverized silk thread pieces Ka′ each having a size of approximately 0.5 to 5.0 mm square are formed. The coarse pulverization of the silk threads K may be performed using a cutter, scissors, a shredder, or the like. In addition, in this embodiment, as shown in FIG. 3A, while being in the form of cocoons, the silk threads K are coarsely pulverized. Since the silk threads K in the form of cocoons are supplied to a shredder or the like and are coarsely pulverized, the coarsely pulverized silk thread pieces Ka′ can be easily obtained.

Next, in a second coarsely pulverizing step of Step S12, the coarsely pulverized silk thread pieces Ka′ are further finely pulverized to form the fibrous coarsely pulverized silk thread material Ka. For the pulverization of the coarsely pulverized silk thread pieces Ka′, for example, a mixer or a high-speed mill may be used. Accordingly, as shown in FIG. 3C, a coarsely pulverized silk thread material Ka having an average fiber length of 0.5 to 5.0 mm is formed.

Subsequently, in a depositing step of Step S13, after being dispersed in air, the coarsely pulverized silk thread material Ka is deposited to form a silk thread deposit H. As shown in FIG. 3D, the coarsely pulverized silk thread material Ka is allowed to fall on a sieve Q1 having meshes. Since the meshes of the sieve Q1 each have a predetermined opening, a coarsely pulverized silk thread material Ka smaller than the opening is allowed to pass through the sieve Q1, and a coarsely pulverized silk thread material Ka larger than the opening stays on the sieve Q1. Accordingly, a coarsely pulverized silk thread material Ka having a desired length can be sorted. The coarsely pulverized silk thread material Ka passing through the sieve Q1 is deposited on a mold releasing sheet M1 disposed under the sieve Q1, so that the silk thread deposit H is formed.

Next, in a moisture imparting step of Step S14, moisture is imparted to the silk thread deposit H. As shown in FIG. 3E, for example, the impartation of moisture is performed using a spray R1 or the like. Water is sprayed from the spray R1 in the form of mist and is adhered to the silk thread deposit H. Since the moisture is imparted to the silk thread deposit H, formation of hydrogen bonds between the coarsely pulverized silk thread material Ka (between fibers) is promoted.

Subsequently, in a molding step of Step S15, the silk thread deposit H is pressurized and heated to form the silk thread molded body Sa. As shown in FIG. 3F, while the silk thread deposit H provided with mold releasing sheets M1 on two surfaces thereof is disposed between a heated upper mold J1 and a heated lower mold J2, the silk thread deposit H sandwiched therebetween is heated and pressurized. In this case, a heating temperature and an applying pressure are set to 40° C. to 100° C. and 10 to 200 MPa, respectively. After a predetermined time passes, the upper mold J1 and the lower mold J2 are opened, and the mold releasing sheets M1 are removed, so that the silk thread molded body Sa is formed to have a sheet shape.

Accordingly, a silk thread molded body Sa excellent in environmental compatibility can be manufactured. In addition, by using a small amount of moisture and by heating at a relatively low temperature, the formation of the silk thread molded body Sa can be performed, and hence, the environmental load can be reduced.

In addition, in this embodiment, although the second coarsely pulverizing step is performed, the method described above is not limited thereto, and the second coarsely pulverizing step may be omitted in some cases. That is, after the moisture is imparted to the coarsely pulverized silk thread pieces Ka′ formed in the first coarsely pulverizing step, heating and pressure application may be performed. By the method as described above, the silk thread molded body Sa may also be manufactured.

### 3. Cellulose Fiber Regenerated Molded Body S

Next, the structure of the cellulose fiber regenerated molded body S will be described. FIG. 4 is a schematic view showing the structure of the cellulose fiber regenerated molded body S. As shown in FIG. 4, the cellulose fiber regenerated molded body S is formed of silk thread fibers Saa of the silk thread molded body Sa and the cellulose fibers Sba of a cellulose fiber molded body Sb.

As the cellulose fibers Sba, for example, natural cellulose fibers and chemical cellulose fibers may be mentioned. In more particular, as the cellulose fibers, for example, there may be mentioned cellulose fibers formed from a cellulose, a cotton, a hemp, a kenaf, a flax, a ramie, a jute, a Manila hemp, a Sisal hemp, a coniferous tree, a broadleaf tree, or a bamboo. Those mentioned above may be used alone, or at least two types thereof may be appropriately used in combination. The cellulose fibers may be regenerated cellulose fibers obtained by refining used copy paper or the like. The cellulose fibers may be processed by various types of surface treatments.

The silk thread fibers Saa contain sericin and fibroin. The structures of sericin and fibroin are the same as described above. In addition, the silk thread fibers Saa are substantially the same as the fibrous coarsely pulverized silk thread material Ka (see FIGS. 1 and 3C) formed from the silk threads.

In the cellulose fiber regenerated molded body S, by the sericin contained in the silk thread fibers Saa, the cellulose fibers Sba are bound together. The sericin is a binding material to bind the cellulose fibers Sba contained in the cellulose fiber regenerated molded body S and shows, by the presence of a small amount of water, an adhesive property at a low temperature of approximately 80° C. Hence, compared to the case in which a synthetic resin having a high softening point is used as the binding material, an electric power consumption of an apparatus which forms the cellulose fiber regenerated molded body S can be decreased. In this case, “by the sericin, the cellulose fibers Sba are bound together” indicates the state in which since the sericin is disposed between the cellulose fibers Sba, the cellulose fibers Sba are not likely to be separated from each other with the sericin interposed therebetween. In addition, the silk thread fibers Saa each have a core-sheath structure, and the sericin is present so as to surround the periphery of the fibroin. Hence, the sericin is able to bind the cellulose fibers Sba together with the fibroin interposed therebetween, and the tensile strength of the cellulose fiber regenerated molded body S can be improved.

The content of the silk thread fibers Saa in the cellulose fiber regenerated molded body S with respect to the total mass of the silk thread fibers Saa and the cellulose fibers Sba is, for example, 12 to 80 percent by mass. Accordingly, a binding force between the cellulose fibers Sba can be increased, and the tensile strength of the cellulose fiber regenerated molded body S can also be improved. In addition, the cellulose fiber regenerated molded body S can be suppressed from being hardened, and hence, printing characteristics and a paper passing property of the cellulose fiber regenerated molded body S can be improved.

The presence of sericin in the silk thread fibers Saa of the cellulose fiber regenerated molded body S can be confirmed, for example, by an infrared absorption method or a scanning electron microscope-energy dispersive X-ray detector (SEM-EDX). The content of the sericin in the cellulose fiber regenerated molded body S can be measured, for example, by an infrared absorption method, a nuclear magnetic resonance (NMR) method, an X-ray diffraction method, or a mass analysis (MALDI-TOF-MS).

The presence of fibroin in the silk thread fibers Saa of the cellulose fiber regenerated molded body S can be confirmed, for example, by an infrared absorption method or a SEM-EDX. The content of the fibroin in the cellulose fiber regenerated molded body S can be measured, for example, by an infrared absorption method, an NMR method, an X-ray diffraction method, or a MALDI-TOF-MS.

In the cellulose fiber regenerated molded body S thus formed, for the binding between the cellulose fibers Sba, the naturally-derived binding material is used. Accordingly, for example, compared to a synthetic resin formed by using petroleum as a raw material, an emission amount of carbon dioxide can be decreased, and in addition, the binding material is biodegradable and is excellent in environmental compatibility.

The cellulose fiber regenerated molded body S can be preferably used as a recording sheet. The recording sheet is, for example, a sheet to be printed by a laser printer, an ink jet printer, or the like. The cellulose fiber regenerated molded body S may be recycled paper containing fibers obtained by defibrating old paper. As the old paper, for example, used copy paper may be mentioned.

The thickness of the cellulose fiber regenerated molded body S is, for example, preferably 0.05 to 1.0 mm and more preferably 0.1 to 0.5 mm. When having a thickness of 0.05 to 1.0 mm, the cellulose fiber regenerated molded body S has a preferable paper passing property to a printer.

The density of the cellulose fiber regenerated molded body S is, for example, 0.5 to 1.0 g/cm³ and preferably 0.7 to 0.9 g/cm³. When having a density of 0.5 g/cm³ or more, the cellulose fiber regenerated molded body S is able to have excellent printing characteristics. When having a density of 1.0 g/cm³ or less, the cellulose fiber regenerated molded body S can be suppressed from being heavier and is able to have an excellent paper passing property to a printer.

### 4. Method for Manufacturing Cellulose Fiber Regenerated Molded Body S

Next, a method for manufacturing the cellulose fiber regenerated molded body S will be described. In this embodiment, a method in which the cellulose fiber molded body Sb, such as old paper, is used as a raw material and is regenerated into the cellulose fiber regenerated molded body S will be described.

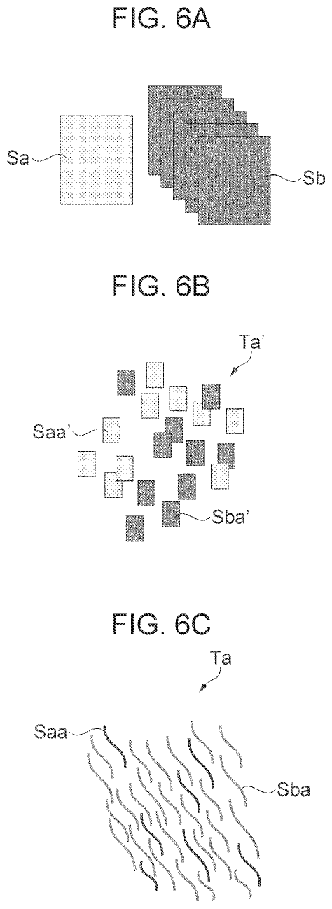

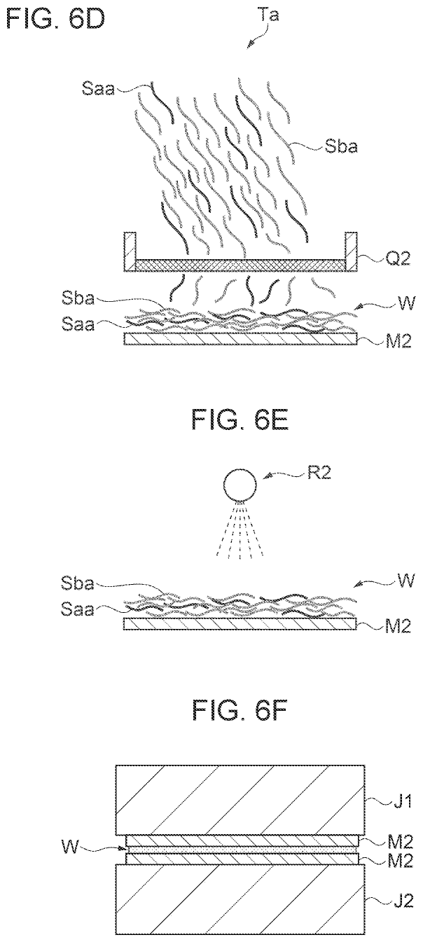

FIG. 5 is a flowchart showing the method for manufacturing the cellulose fiber regenerated molded body S. FIGS. 6A to 6F are schematic views each showing the method for manufacturing the cellulose fiber regenerated molded body S.

In a coarsely pulverizing step of Step S21, as shown in FIG. 6A, at least one silk thread molded body Sa and at least one cellulose fiber molded body Sb, each having a sheet shape, are prepared and then coarsely pulverized. In addition, the structure of the silk thread molded body Sa is as described above.

In the coarsely pulverizing step, the silk thread molded body Sa and the cellulose fiber molded body Sb are coarsely pulverized together. That is, the silk thread molded body Sa and the cellulose fiber molded body Sb are coarsely pulverized by the same coarsely pulverizing portion, such as a shredder. Since the silk thread molded body Sa has a sheet shape, in particular, by using a shredder or the like, the silk thread molded body Sa can be easily coarsely pulverized simultaneously with the cellulose fiber molded body Sb. Accordingly, as shown in FIG. 6B, a coarsely pulverized material Ta′ is formed in the state in which a coarsely pulverized silk thread material Saa′ and a coarsely pulverized cellulose fiber material Sba′ are mixed together. The coarsely pulverized silk thread material Saa′ and the coarsely pulverized cellulose fiber material Sba′ forming the coarsely pulverized material Ta′ are each in the form of approximately 0.5 mm to 5.0 mm-square pieces.

In the case described above, a coarsely pulverizing amount of the silk thread molded body Sa with respect to the total mass of the coarsely pulverizing amount of the silk thread molded body Sa and a coarsely pulverizing amount of the cellulose fiber molded body Sb is 12 to 80 percent by mass. When the rate described above is obtained, the tensile strength of the cellulose fiber regenerated molded body S to be regenerated can be improved.

Next, in a defibrating step of Step S22, the coarsely pulverized material Ta′ is further finely pulverized (defibrated) using a mixer or a high-speed mill to form a fibrous defibrated material Ta. As shown in FIG. 6C, the defibrated material Ta is formed in the state in which the silk thread fibers Saa and the cellulose fibers Sba, each of which is defibrated, are mixed together. The average fiber length of each of the silk thread fibers Saa and the cellulose fibers Sba is 0.5 to 5.0 mm. Accordingly, the tensile strength of the cellulose fiber regenerated molded body S to be obtained can be further improved.

Subsequently, in a depositing step of Step S23, the defibrated material Ta is dispersed in air and then deposited to form a deposit W. As shown in FIG. 6D, the defibrated material Ta is allowed to fall on a sieve Q2 having meshes. Since the meshes of the sieve Q2 have predetermined openings, a defibrated material Ta smaller than the openings is allowed to pass through the sieve Q2, and a defibrated material Ta larger than the openings stays on the sieve Q2. Hence, a defibrated material Ta having a desired length can be sorted. The defibrated material Ta passing through the sieve Q2 is deposited on a mold releasing sheet M2 disposed under the sieve Q2, so that the deposit W is formed. In addition, this deposit W is also formed in the state in which the silk thread fibers Saa and the cellulose fibers Sba are mixed together.

Next, in a moisture imparting step of Step S24, moisture is imparted to the deposit W. As shown in FIG. 6E, the impartation of moisture is performed, for example, using a spray R2 or the like. Water is sprayed from the spray R2 in the form of mist and is adhered to the deposit W. Since the moisture is applied to the deposit W, formation of hydrogen bonds between the silk thread fibers Saa and the cellulose fibers Sba is promoted.

In this case, an imparting amount of the moisture with respect to the total mass of the deposit W is preferably 5 to 20 percent by mass. That is, compared to the case in which a cellulose fiber regenerated molded body is manufactured by a related wet type method, since a necessary moisture amount is significantly small, the environmental compatibility is excellent.

Subsequently, in a molding step of Step S25, the deposit W is pressurized and heated, so that the cellulose fiber regenerated molded body S is obtained. In this embodiment, a heat press molding machine including an upper mold J1 and a lower mold J2 is used. As shown in FIG. 6F, after the deposit W provided with mold releasing sheets M2 on two surfaces thereof is disposed between the upper mold J1 and the lower mold J2, the deposit W sandwiched therebetween is heated and pressurized. In this case, a heating temperature and an applying pressure are set to 40° C. to 100° C. and 10 to 200 MPa, respectively. After a predetermined time passes, the upper mold J1 and the lower mold J2 are opened, and the mold releasing sheets M2 are removed, so that the cellulose fiber regenerated molded body S is formed to have a sheet shape.

In addition, in the molding step of this embodiment, although the heat press molding machine is used, the machine is not limited thereto, and for example, a heat roller machine, a hot plate, a hot wind blower, an infrared heater, or a flash fusing device may also be used. Among those mentioned above, since the pressure application and the heating can be simultaneously performed, and the manufacturing process can be simplified, a heat press molding machine or a heat roller machine is preferably used.

According to the method for manufacturing the cellulose fiber regenerated molded body S of this embodiment, since the naturally-derived silk thread fibers Saa are used as the binding material to bind the cellulose fibers Sba together, the binding material can be fully formed from a naturally-derived material. In addition, compared to a synthetic resin formed by using petroleum as a raw material, since an emission amount of carbon dioxide can be decreased, and the binding material is biodegradable, a cellulose fiber regenerated molded body S excellent in environmental compatibility can be manufactured.

In addition, in the coarsely pulverizing step, since the coarsely pulverized cellulose fiber material Sba′ and the coarsely pulverized silk thread material Saa′ are mixed together, a step of supplying the coarsely pulverized silk thread material Saa′ to the coarsely pulverized cellulose fiber material Sba′ and a step of mixing the coarsely pulverized materials described above are not required, and hence, the process can be simplified.

In addition, in the moisture imparting step, compared to a method performed by a related wet system, an amount of moisture necessary for the manufacturing can be significantly decreased. In addition, in the molding step, compared to a dry manufacturing method, such as a related technique, using a synthetic resin, the heating temperature can be significantly decreased. That is, an electric power consumption and an environmental load required for the manufacturing of the cellulose fiber regenerated molded body S can be decreased.

In addition, in this embodiment, although the defibrating step is performed, this step may be omitted in some cases. That is, from the coarsely pulverized material Ta′ in which the coarsely pulverized cellulose fiber material Sba′ and the coarsely pulverized silk thread material Saa′ are mixed together, the cellulose fiber regenerated molded body S may also be formed. Even when the defibrating step is omitted as described above, an effect similar to that described above may also be obtained.

### 5. Cellulose Fiber Regenerated Molded Body Manufacturing Apparatus 100

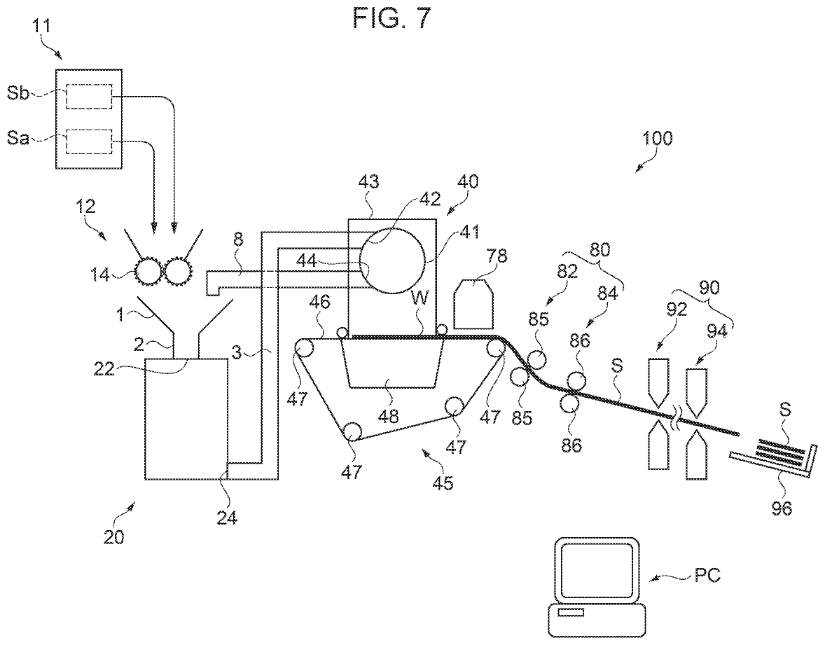

Next, a cellulose fiber regenerated molded body manufacturing apparatus 100 capable of manufacturing the cellulose fiber regenerated molded body S will be described. FIG. 7 is a schematic view showing the cellulose fiber regenerated molded body manufacturing apparatus 100.

As shown in FIG. 7, the cellulose fiber regenerated molded body manufacturing apparatus 100 includes a supply portion 11, a coarsely pulverizing portion 12, a defibrating portion 20, a depositing portion 40, a web forming portion 45, a moisture imparting portion 78, a cellulose fiber regenerated molded body forming portion 80, and a cutting portion 90. In addition, a computer PC including a control portion which controls the portions described above is also included.

The supply portion 11 supplies at least one silk thread molded body Sa and at least one cellulose fiber molded body Sb, each of which has a sheet shape, to the coarsely pulverizing portion 12. The supply portion 11 is, for example, an automatic feeding portion to continuously feed the silk thread molded body Sa and the cellulose fiber molded body Sb to the coarsely pulverizing portion 12. The cellulose fiber molded body Sb used as a raw material is, for example, old paper.

In this embodiment, the silk thread molded body Sa and the cellulose fiber molded body Sb are supplied together to the coarsely pulverizing portion 12. That is, the silk thread molded body Sa and the cellulose fiber molded body Sb are supplied at the same time to the same coarsely pulverizing portion 12. Since having a sheet shape, the silk thread molded body Sa can be transported in a manner similar to that for the cellulose fiber molded body Sb and can be easily supplied from the automatic feeding portion of the supply portion 11.

In addition, a coarsely pulverizing amount of the silk thread molded body Sa in the coarsely pulverizing portion 12 with respect to the total mass of the coarsely pulverizing amount of the silk thread molded body Sa and a coarsely pulverizing amount of the cellulose fiber molded body Sb is controlled in a range of 12 to 80 percent by mass by the computer PC. That is, by the computer PC, a supply rate of the silk thread molded body Sa and the cellulose fiber molded body Sb is controlled. In particular, the computer PC includes a control portion and an input portion, and when the supply rate of the silk thread molded body Sa and the cellulose fiber molded body Sb is input in the input portion, the control portion calculates the supply amounts thereof and drives the supply portion 11 based on the result of the calculation. Accordingly, desired supply amounts of the silk thread molded body Sa and the cellulose fiber molded body Sb can be controlled.

The coarsely pulverizing portion 12 cuts, in a gas atmosphere, such as in the air, the silk thread molded body Sa and the cellulose fiber molded body Sb supplied by the supply portion 11 into small pieces. The small pieces each have, for example, a 0.5 to 5.0 mm-square size. In the example shown in the drawing, the coarsely pulverizing portion 12 has coarsely pulverizing blades 14 and can cut by the coarsely pulverizing blades 14, the silk thread molded body Sa and the cellulose fiber molded body Sb thus supplied. As the coarsely pulverizing portion 12, for example, a shredder may be used. Since having a sheet shape, the silk thread molded body Sa can be cut in a manner similar to that for the cellulose fiber molded body Sb. In addition, a coarsely pulverized material cut by the coarsely pulverizing portion 12 is formed in the state in which the silk thread molded body Sa and the cellulose fiber molded body Sb are mixed together. The coarsely pulverized material is received in a hopper 1 and then transferred to the defibrating portion 20 through a tube 2.

The defibrating portion 20 further finely pulverizes the coarsely pulverized material cut by the coarsely pulverizing portion 12. In this embodiment, the coarsely pulverized material is defibrated into a defibrated material. In this case, “defibrate” indicates that the silk thread molded body Sa and the cellulose fiber molded body Sb are each disentangled into independent fibers. In addition, the defibrating portion 20 also has a function to separate materials, such as resin particles, inks, toners, and a blurring inhibitor, adhered to the cellulose fiber molded body Sb from the fibers.

In the defibrated material passing through the defibrating portion 20, besides the disentangled fibers, for example, resin particles, colorants, such as inks and toners, and additives, such as a blurring inhibitor and a paper strength improver, which are separated from the fibers when the fibers are disentangled may also be contained in some cases. The defibrated material is in the form of strings. The defibrated material may be present while being not entangled with other disentangled fibers, that is, in the independent state, or may also be present while being entangled with other disentangled fibers to form aggregates, that is, in the state in which damas are formed.

The defibrating portion 20 performs defibration by a dry method. In this case, a treatment, such as defibration, performed not in liquid but in a gas atmosphere, such as in the air, is called a dry method. As the defibrating portion 20, for example, an impeller mill is used. The defibrating portion 20 has a function to generate an air stream to suck the raw material and to discharge the defibrated material. Accordingly, by the air stream generated as described above, the defibrating portion 20 can suck the raw material from an inlet port 22 together with the air stream, perform a defibrating treatment, and then transport the defibrated material to a discharge port 24. The defibrated material passing through the defibrating portion 20 is transferred to the depositing portion 40 through a tube 3. In addition, as an air stream to transport the defibrated material from the defibrating portion 20 to the depositing portion 40, the air stream generated in the defibrating portion 20 may also be used, or an air stream generated by an air stream generator, such as a blower, may be used.

The depositing portion 40 introduces the defibrated material defibrated in the defibrating portion 20 from an inlet port 42 and then sorts the defibrated material by the lengths of the fibers. In addition, the depositing portion 40 disperses the defibrated material in air to form a web W (deposit W).

The depositing portion 40 includes, for example, a drum portion 41 and a housing portion 43 receiving the drum portion 41. As the drum portion 41, for example, a sieve is used. The drum portion 41 has a net, and fibers or particles smaller than openings of the net, that is, a first sorted material to pass through the net, can be separated from fibers, non-defibrated pieces, and damas larger than the openings of the net, that is, a second sorted material not to pass through the net. For example, the first sorted material is deposited on a mesh belt 46 to form the web W. The second sorted material is returned to the defibrating portion 20 from a discharge port 44 through a tube 8. In particular, the drum portion 41 is a cylindrical sieve rotatably driven by a motor. As the net of the drum portion 41, for example, a metal net, an expanded metal formed by expanding a metal plate provided with cut lines, or a punched metal in which holes are formed in a metal plate by a press machine or the like may be used.

The web forming portion 45 includes, for example, the mesh belt 46, tension rollers 47, and a suction mechanism 48.

While being transferred, the mesh belt 46 deposits the first sorted material passing through the openings of the depositing portion 40. The mesh belt 46 is stretched by the tension rollers 47 and has the structure in which air is supplied so that the first sorted material is not likely to pass through. The mesh belt 46 is transferred by the rotation of the tension rollers 47. While the mesh belt 46 is continuously transferred, the first sorted material passing through the depositing portion 40 is allowed to continuously fall down, so that the web W is formed by deposition thereof on the mesh belt 46.

The suction mechanism 48 is provided under the mesh belt 46. The suction mechanism 48 can generate a downward air stream. By the suction mechanism 48, the first sorted material dispersed in air by the depositing portion 40 can be sucked on the mesh belt 46. Accordingly, a discharge rate from the depositing portion 40 can be increased. Furthermore, by the suction mechanism 48, a downflow can be formed in a path in which the first sorted material falls, and the defibrated material and the additives are prevented from being entangled with each other during the falling. Accordingly, a web W softly expanded with a large amount of air incorporated therein is formed.

The moisture imparting portion 78 imparts moisture to the web W on the mesh belt 46. As long as being capable of imparting moisture, the moisture imparting portion 78 is not particularly limited, and for example, a spray or the like may be used. In addition, an imparting amount of moisture with respect to a predetermined deposition amount of the web W is 5 to 20 percent by mass. In addition, the web W is transported to the cellulose fiber regenerated molded body forming portion 80.

The cellulose fiber regenerated molded body forming portion 80 pressurizes and heats the web W to which the moisture is imparted to form a new cellulose fiber regenerated molded body S. The cellulose fiber regenerated molded body forming portion 80 includes a pressurizing portion 82 to pressurize the web W and a heating portion 84 to heat the web W which is pressurized by the pressurizing portion 82.

The pressurizing portion 82 is formed, for example, of a pair of calendar rollers 85 and pressurizes the web W. Since the web W is pressurized, the thickness thereof is decreased, and the density of the web W is increased.

As the heating portion 84, for example, a heat roller machine, a heat press molding machine, a hot plate, a hot wind blower, an infrared heater, or a flash fusing device may be used. In the example shown in the drawing, the heating portion 84 includes a pair of heating rollers 86. Since the heating portion 84 is formed of the heating rollers 86, compared to the case in which the heating portion 84 is formed of a plate-shaped press device, the cellulose fiber regenerated molded body S can be formed while the web W is continuously transported. Since the heating is performed by the heating portion 84, a binding function of the silk thread fibers Saa is exhibited, and the cellulose fibers Sba are bound to each other. In addition, the heating temperature is 40° C. to 100° C. The moisture imparted to the web W is evaporated by the heating of the heating portion 84. The calendar rollers 85 and the heating rollers 86 are disposed, for example, so that the rotation shafts thereof are in parallel to each other. In this case, the calendar rollers 85 can apply a high pressure to the web W as compared to that to be applied to the web W by the heating rollers 86. In addition, the number of the calendar rollers 85 and the number of the heating rollers 86 are not particularly limited.

The cutting portion 90 cuts the cellulose fiber regenerated molded body S formed by the cellulose fiber regenerated molded body forming portion 80. In the example shown in the drawing, the cutting portion 90 includes a first cutting portion 92 to cut the cellulose fiber regenerated molded body S in a direction intersecting the transport direction of the cellulose fiber regenerated molded body S and a second cutting portion 94 to cut the cellulose fiber regenerated molded body S in a direction parallel to the transport direction thereof. The second cutting portion 94 cuts, for example, the cellulose fiber regenerated molded body S passing through the first cutting portion 92.

As described above, a single sheet-shaped cellulose fiber regenerated molded body S having a predetermined size is formed. The single cellulose fiber regenerated molded body S thus cut is discharged to a discharge portion 96.

In the cellulose fiber regenerated molded body manufacturing apparatus 100, the silk thread molded body Sa and the cellulose fiber molded body Sb are supplied together to the coarsely pulverizing portion 12. Accordingly, the coarsely pulverized material in which the silk thread molded body Sa and the cellulose fiber molded body Sb are mixed together is formed. In addition, in the defibrating portion 20, since the coarsely pulverized material in which the silk thread molded body Sa and the cellulose fiber molded body Sb are mixed together is defibrated, the defibrated material in which the silk thread molded body Sa and the cellulose fiber molded body Sb are mixed together is formed. Hence, since a mixing portion in which the silk thread molded body Sa and the cellulose fiber molded body Sb are mixed together, a supply portion which supplies the silk thread fibers Saa to the cellulose fibers Sba which are defibrated, and the like are not required to be additionally provided, the size of the cellulose fiber regenerated molded body manufacturing apparatus 100 can be decreased.

In addition, in the depositing portion 40, the silk thread fibers Saa and the cellulose fibers Sba are dispersed in air and are then formed into the web W. In this case, for example, when the cellulose fibers Sba and silk thread molded body particles (powder) are dispersed in air, since being smaller than the silk thread fibers Saa in the form of fibers, the silk thread molded body particles are liable to fall down from the mesh belt 46. Hence, the binding force between the cellulose fibers Sba is decreased. On the other hand, in this embodiment, since being in the form of fibers, the silk thread fibers Saa is not likely to fall even if being dispersed. Hence, the binding force between the cellulose fibers Sba is increased, and the tensile strength of the cellulose fiber regenerated molded body S can be improved.

What is claimed is:

1. A silk thread molded body obtained by molding a coarsely pulverized silk thread material which is prepared by coarsely pulverizing silk threads.

2. The silk thread molded body according to claim 1,
wherein the silk thread molded body has a sheet shape.

3. The silk thread molded body according to claim 1,
wherein the coarsely pulverized silk thread material has an average fiber length of 0.5 to 5.0 mm.

4. A method for manufacturing a silk thread molded body, the method comprising:
a coarsely pulverizing step of coarsely pulverizing silk threads to obtain a coarsely pulverized silk thread material;
a depositing step of dispersing in air and depositing the coarsely pulverized silk thread material to obtain a silk thread deposit;
a moisture imparting step of imparting moisture to the silk thread deposit; and
a molding step of pressurizing and heating the silk thread deposit to which the moisture is imparted to obtain a silk thread molded body.

5. The method for manufacturing a silk thread molded body according to claim 4,
wherein in the coarsely pulverizing step, while being in the form of cocoons, the silk threads are coarsely pulverized.

6. A method for manufacturing a cellulose fiber regenerated molded body, the method comprising:
a coarsely pulverizing step of coarsely pulverizing the silk thread molded body according to claim 1 and a cellulose fiber molded body to obtain a coarsely pulverized material;
a depositing step of dispersing in air and depositing the coarsely pulverized material to obtain a deposit;
a moisture imparting step of imparting moisture to the deposit; and
a molding step of pressurizing and heating the deposit to which the moisture is imparted to obtain a cellulose fiber regenerated molded body.

7. The method for manufacturing a cellulose fiber regenerated molded body according to claim 6,
wherein in the coarsely pulverizing step, the silk thread molded body and the cellulose fiber molded body are coarsely pulverized together.

8. The method for manufacturing a cellulose fiber regenerated molded body according to claim 6,
wherein in the moisture imparting step, an imparting amount of the moisture with respect to the total mass of the deposit is 5 to 20 percent by mass.

9. The method for manufacturing a cellulose fiber regenerated molded body according to claim 6,
wherein in the molding step, the heating is performed at a temperature of 40° C. to 100° C.

10. The method for manufacturing a cellulose fiber regenerated molded body according to claim 6,
wherein in the coarsely pulverizing step, a coarsely pulverizing amount of the silk thread molded body with respect to the total mass of the coarsely pulverizing amount of the silk thread molded body and a coarsely pulverizing amount of the cellulose fiber molded body is 12 to 80 percent by mass.
